(19) United States
(12) Patent Application Publication
(10) Pub. No.: US 2004/0237798 A1
(43) Pub. Date: Dec. 2, 2004

(54) Hot mixer or steam blender

(76) Inventor: Ann Elizabeth Payne, Chicago, IL (US)

Correspondence Address: Ann Payne, c/o Thomas G. Scavone, Suite 4600, 181 West Madison Street, Chicago, IL, 60602, US

(21) Appl. No.: 10/673,787

(22) Filed: Sep. 30, 2003

Related U.S. Application Data
(60) Provisional application No. 60/414,744, filed on Sep. 30, 2002.

(51) Int. Cl. A23L 1/00

(52) U.S. Cl. 99/348

(57) ABSTRACT

A versatile food and beverage preparation device that combines the advantages of steam cooking, the mixing action generated by a steam jet espresso frothing nozzle and a food processor.

### BACKGROUND

The inventor introduced the frothing/steam nozzle on espresso machines to foods and other beverages, thereby inventing a new product. Coffee and espresso machines are designed for coffee, espresso and cappuccino, not vegetables and fish. The present invention is designed to cook, mix and process a variety of foods and beverages.

The present invention heats, cooks and mixes foods and beverages such as baby foods, vegetables, and meats and simultaneously cooks pasta and sauce. The present invention includes a variety of containers specific to foods and soups, a timing mechanism, twin and single steam jet attachments and a food processor attachment.

Currently many soups are made by steaming vegetables, transferring said vegetables to a blender or food processor and then returning said vegetables to a stove top for final ingredients and to reheat. The present invention reduces this cumbersome three product process to one product.

These and other objects of the invention are achieved in a product that combines; a coffee maker, a stand mixer, an espresso maker, a food steamer and a food processor. The product utilizes containers appropriate for the foods being prepared and or cooked. The invention includes a timing mechanism and built in safety features.

### SUMMARY

An object of the present invention is to provide a convenient method of cooking and preparing a variety of foods and beverages. It is further the object for the present invention to provide a single product for cooking and preparing soups from raw vegetables and meats. It is further the object of the present invention to provide a single product that prepares both pasta and sauce.

### BRIEF DESCRIPTION OF THE DRAWINGS

With additional features and a new method of steaming the invention is an improvement on the food steamer. Steam is generated for mixing, heating and cooking foods and beverages, similar to the way in which water is heated in a common coffee maker and steam is generated in an espresso machine. As water in the reservoir begins to boil, steam is generated and displaced through the nozzle, creating a jet of steam. A departure from the espresso machine, steam is used to cook foods in addition to heating and mixing liquids. The flow of steam may be modified from mist to mix with an adjustment valve and by using the appropriate nozzle attachment and or the orifice within the selected attachment, depending on the cooking/mixing requirements of the food or beverage. Food preparation is available with a food processor attachment that receives power from the stand. The processing tool is formed by at least one rotary cutter for pureeing, blending and or chopping food materials.

### DETAILED DESCRIPTION

Food preparation device with a motor drive assembly

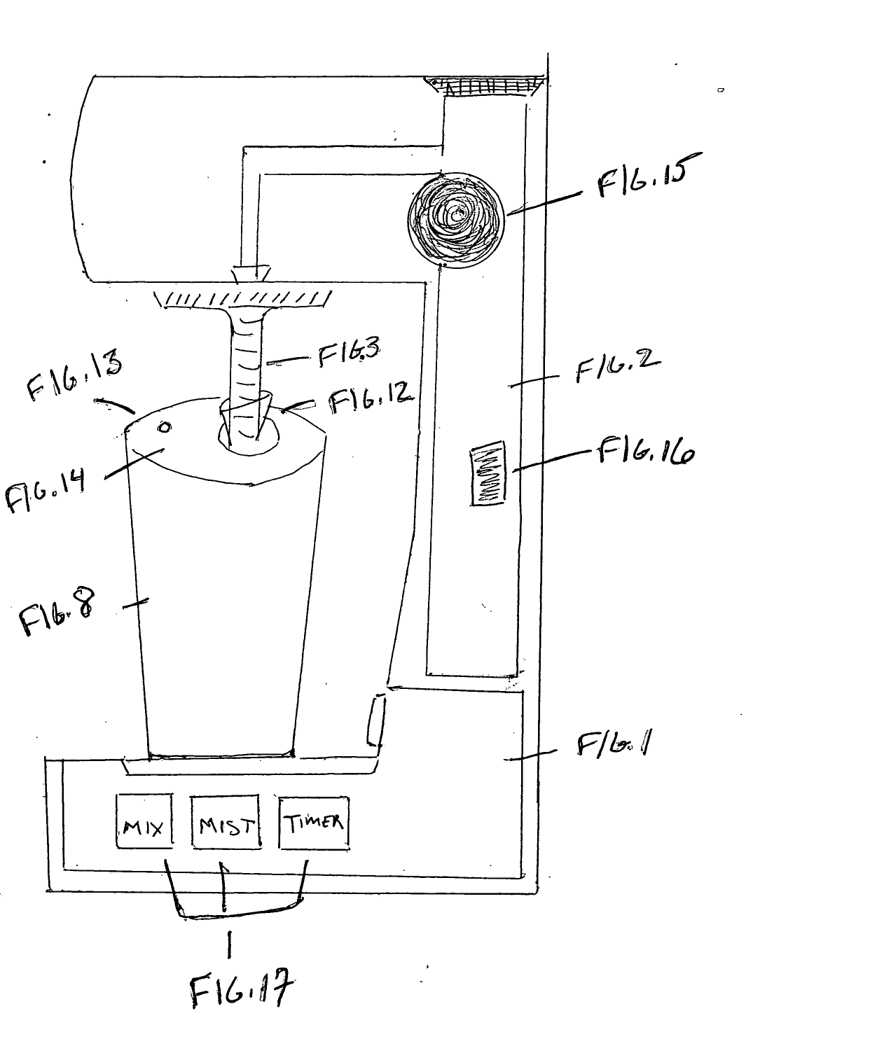

FIG. 1 that heats water in a reservoir

FIG. 2 until it turns into steam and is displaced through a single nozzle

FIG. 3, twin nozzle

FIG. 4 or mix to mist nozzle

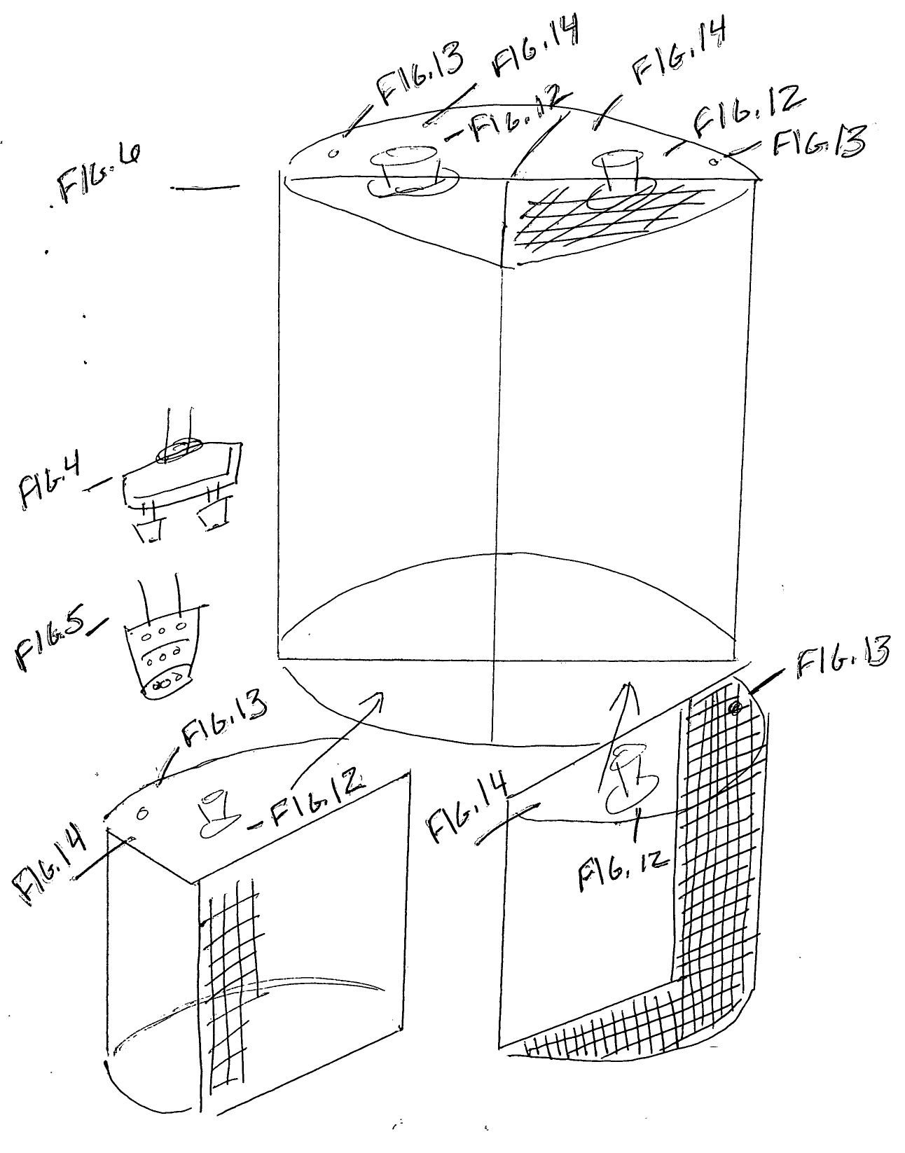

FIG. 5, into a container specific to the cooking requirements; a twin container

FIG. 6, food processing container

FIG. 7, tall container

FIG. 8 or oblong container

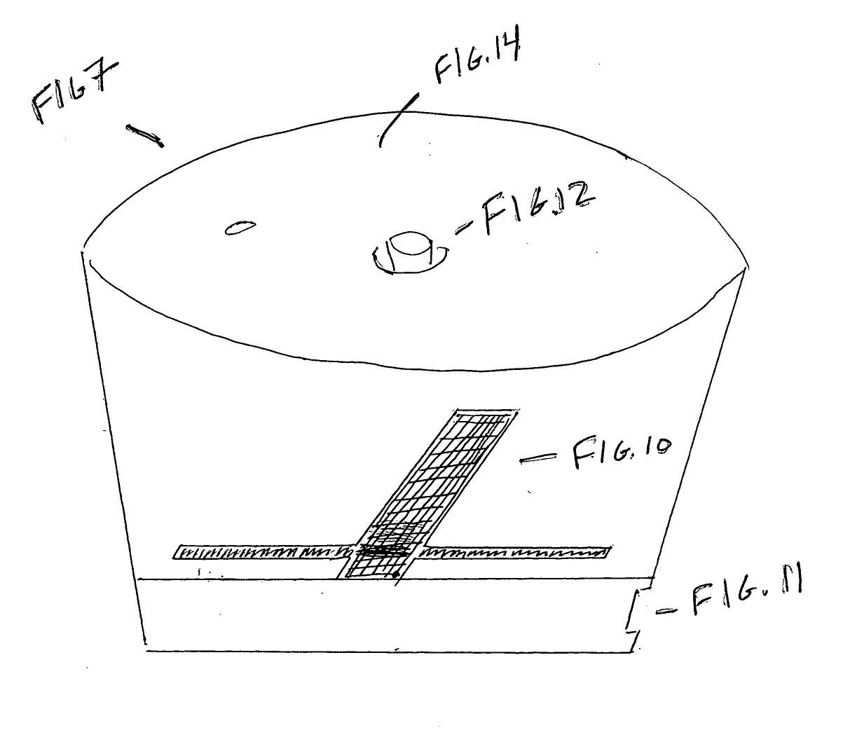

FIG. 9. Food processing container FIG. 7 is comprised of at least one rotary cutter

FIG. 10 and a power receptacle device

FIG. 11. Said containers have a container to nozzle locking device

FIG. 12 and steam release orifice

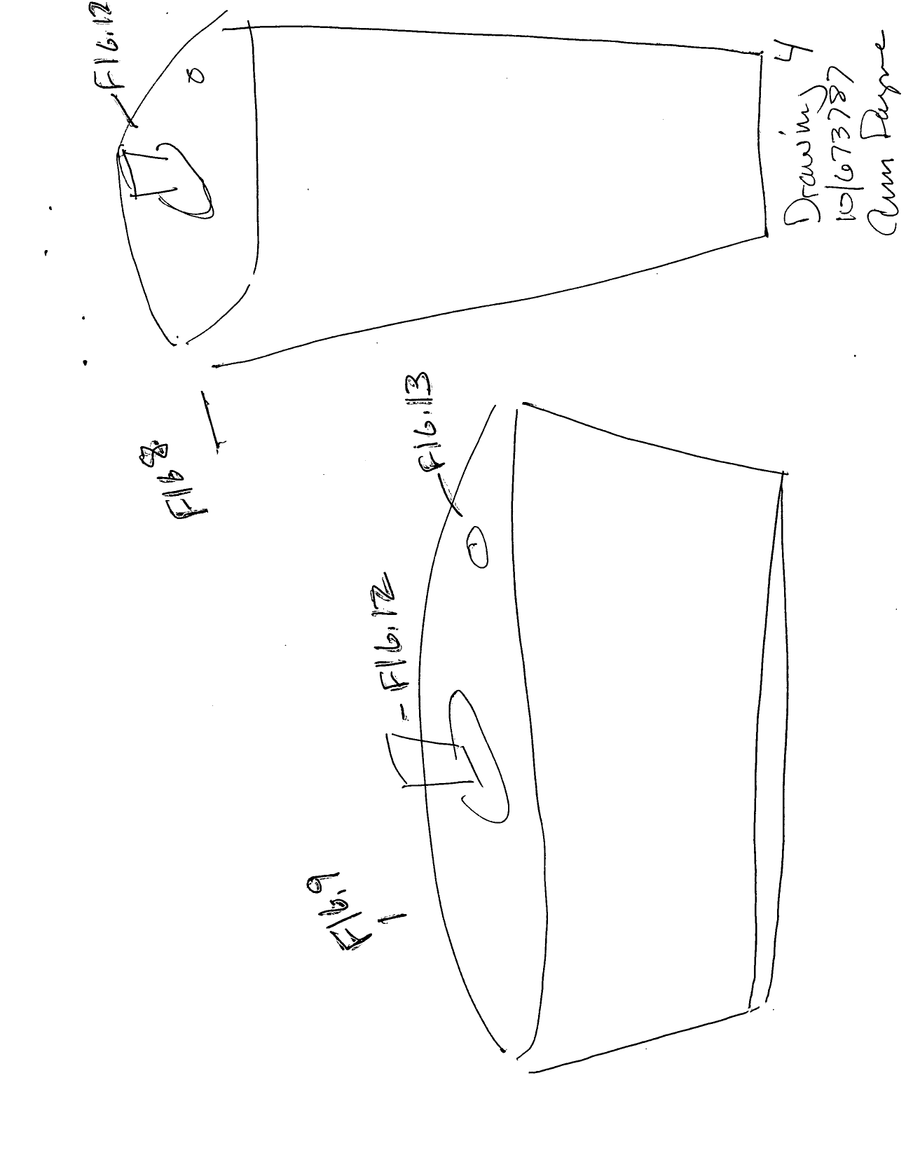

FIG. 13 in the lids

FIG. 14. Stand adjustment knob

FIG. 15 tilts the head to fit the containers and the height adjustment knob

FIG. 16 moves the stand vertically to accommodate the containers. Manual or touch screen steam adjustment controls

FIG. 17, control the flow of steam infused into selected container.

What I claim as my invention is:

1. A food preparation device that allows one to; cook and mix foods and beverages with steam, process foods with a blade, cook two foods separately at once, control steam with a selection of nozzles and a mix to mist manual or touch screen adjustment valve and monitor cooking time.

2. A food preparation device according to claim 1 that includes containers with the following; container to steam nozzle safety locking device, steam release orifice, twin containers for cooking two foods separately at once and food processing container with a blade and power receptacle.

3. Said containers according to claim 2 include lids in which the steam nozzle safety device and steam release orifice reside.

4. A food preparation device according to claim 1 that may be adjusted to accommodate containers according to claim 2.

5. A selection of steam nozzles that deliver steam from the water reservoir to foods and beverages in containers according to claim 2 including; a single steam jet nozzle, a twin nozzle attachment and a steam-mist attachment.

6. A system wherein the flow of steam is controlled using steam nozzles according to claim 5 and a mist to mix control valve according to claim 1.
